(19) United States
(12) Patent Application Publication
(10) Pub. No.: US 2011/0212378 A1
(43) Pub. Date: Sep. 1, 2011

(54) FUEL CELL ARRANGEMENT WITH FUEL CELLS DISPOSED IN A SHINGLE CONSTRUCTION AND ALSO PURPOSES OF USE

(75) Inventors: Mario Zedda, Freiburg (DE); Michael Oszcipok, Freiburg (DE)

(73) Assignee: Fraunhofer-Gesellschaft Zur Forderung Der Angewandten Forschung E.V., Munchen (DE)

(21) Appl. No.: 12/673,303

(22) PCT Filed: Oct. 23, 2008
(86) PCT No.: PCT/EP2008/008966

§ 371 Date: Jul. 12, 2010

(30) Foreign Application Priority Data
Oct. 23, 2007 (DE) 10 2007 050 617.3

(51) Int. Cl. H01M 8/24; H01M 8/10

(52) U.S. Cl. 429/455; 429/454

(57) ABSTRACT

The present invention relates to a fuel cell arrangement which comprises at least two single fuel cells, the single fuel cells being disposed non-parallel to each other, i.e. being disposed offset or in a shingle construction relative to each other.

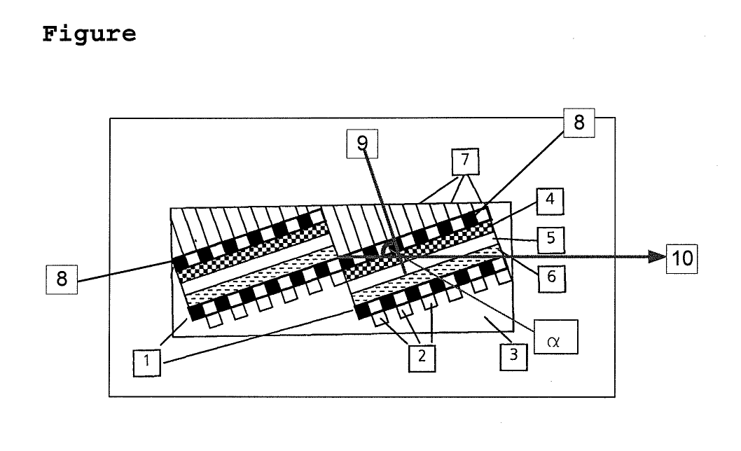

The present invention relates to a fuel cell arrangement which comprises at least two single fuel cells, the single fuel cells being disposed non-parallel to each other, i.e. being disposed offset or in a shingle construction relative to each other.

The electrical wiring of a plurality of electrochemical cells is implemented in stack arrangements via electrically conductive layers, for example graphite plates. Frequently such stacked fuel cells are unsuitable for integration in specific applications because of their aspect ratio. Alternatively to this stack construction, fuel cells can also be arranged in one plane. The electrical wiring can be undertaken then by conductive layers, the anode of the one cells contacting the cathode of the adjacent cells for voltage addition. These conductive layers are disposed parallel to form the overall construction of the planar fuel cell. Consequently, the electrical connection of the adjacent cells is possible only via externally guided contacts. This requires additional constructional space and increases the voltage losses due to extended electrical lines and hence higher electrical resistances.

The electrical wiring has been resolved to date in planar arrangements via externally guided contacts or with the help of angled current dischargers. In particular the angled current dischargers are not able to compensate for thickness changes in the typical fuel cell layer construction which occur during operation. As a result, the contact resistance between current discharger and fuel cell electrode changes and is impaired and hence impairs the power output.

Starting from the disadvantages of the state of the art, it was therefore the object of the present invention to provide a fuel cell arrangement in which electrical wiring of a plurality of single cells is ensured, the electrical wiring being able to be achieved as simply as possible and as far as possible without additional current dischargers.

This object is achieved by the fuel cell according to patent claim 1 and also by the purposes of use indicated in patent claim 16. The dependent claims respectively thereby represent advantageous developments.

According to the invention, a fuel cell is hence provided, comprising at least two electrochemical single cells, each electrochemical single cell being constructed at least from the following components:
a) at least one current discharger structure disposed on the anode side,
b) a supply possibility for fuel,
c) an electrode-membrane arrangement (MEA), comprising an anode-side electrode, a membrane and also a cathode-side electrode,
d) a supply possibility for the oxidant, and also
e) at least one current discharger structure disposed on the cathode side,
   each electrochemical single cell being connected electrically directly to at least one adjacent electrochemical single cell and being disposed offset relative to the at least one adjacent electrochemical single cell.

It is hence essential to the invention that the single cells are connected electrically directly to each other. For example in the case of an arrangement of single cells connected in series, this takes place in that the cathode of the first cell is connected directly to the anode of the second cell. There is thereby understood by a direct connection that the electrodes of the fuel cell are contacted with each other preferably without further means for connection of the electrodes, such as for example cables, wires or contacts. It is thereby essential that the fuel cells are disposed not linearly but offset, preferably are disposed non-parallel.

As a result of the proposed solution path, the following advantages result:

Thickness variations can be compensated for as with a fuel cell stack, the current dischargers do not require any highly precise edging and can hence be produced substantially more economically.

Because of the mechanical flexibility of the layer construction, the fuel cells can be glued to the current dischargers via spacers. No forces act mechanically on this adhesive as is the case with angled current dischargers. As a result, it becomes possible to produce a seal by glueing.

A further advantage of the shingle arrangement is that the fuel cell supply channels are disposed at an incline to the installation plane of the fuel cell. As a result, the discharge of gaseous by-products from the anode distributor structure is assisted in a passive manner.

As a result of the integrated electrical wiring, it is possible to transport the current on the largest conducting cross-section, namely over the entire width of the one electrode to the adjacent one. As a result, the shortest paths for the electrical current which are possible in planar cells result and the ohmic resistance is reduced.

An essential advantage also resides in the one-part construction of the electrical connection. There are no additional contact resistances which are dependent upon the contact pressure. In the case of the connection of two current dischargers which are separate from each other, a large contact surface always required to be ensured with conventional solutions.

In particular, it is advantageous with the present invention if the fuel cells are disposed in a shingle construction. There should thereby be understood that the non-parallel mode of arrangement of the fuel cells is designed such that these are disposed rotated or tilted relative to each other in the constructional direction, i.e. in the direction of the vector in which the single cells are connected.

The arrangement of the fuel cells is thereby possible in one and/or in two dimensions.

Furthermore, it is advantageous if the at least two electrochemical single cells are disposed one-dimensionally such that the normal to the current discharger structures, respectively with the directional vector in the direction of which the single cells are connected includes an angle α which is between 5° and 85° . In the normal case, fuel cells have a construction in which both current discharger structures which delimit the fuel cells are disposed plane-parallel to each other. The result consequently is one more or less monolithic, cuboid structure of the individual fuel cells. The arrangement of the fuel cells is now effected preferably such that the normals to the current discharger structures of the individual fuel cells are disposed tilted relative to each other, the fuel cells respectively being in direct contact with each other.

The result hereof is that preferably each electrochemical single cell is connected directly in series to at least one adjacent electrochemical single cell.

Furthermore, it is preferred if the fuel cell contains at least three electrochemical single cells, the terminal single cells of the fuel cell respectively being connected electrically directly to an adjacent single cell, whilst the at least one single cell disposed therebetween is connected respectively electrically directly to respectively two adjacent single cells.

Particular embodiments of the fuel cell provide that, in the case of the terminal electrochemical single cells of the fuel cell respectively, either the current discharger structure disposed on the anode side or cathode side is not connected to an adjacent single cell, whilst, in the case of the single cells disposed therebetween, both the current discharger structure disposed on the anode side and cathode side is connected to respectively at least one adjacent single cell.

It is likewise of advantage if the one terminal electrochemical single cell has a current discharger structure disposed on the anode side, which is not connected to an adjacent electrochemical single cell and the other terminal electrochemical single cell has a current discharger structure disposed on the cathode side, which is not connected to an adjacent single cell.

A further embodiment provides that respectively both the current discharger structure, disposed on the anode side, of an electrochemical single cell disposed between the terminal electrochemical single cell of the fuel cell is connected electrically directly to the current discharger structure, disposed on the cathode side, of its adjacent single cell and respectively the current discharger structure, disposed on the cathode side, of this single cell is connected electrically directly to the current discharger structure, disposed on the anode side, of its adjacent single cell.

Furthermore, the plurality of single cells of the fuel cell is integrated preferably in one housing. In particular, it is thereby provided that the fuel cells are disposed in one plane in the housing, which plane does not extend parallel to the housing walls. It is hereby understood according to the invention that the plane in which the single cells are tilted (e.g. by the angle α) extends non-parallel to the housing walls in the direction of which the tilting is effected.

A further preferred construction of the fuel cell provides that the at least two electrochemical single cells are glued together via spacers. The membrane-electrode arrangements of two adjacent cells are hereby glued on the front- or rear-side of a common current discharger and in fact in such a manner that, with the help of frame-like spacers, which are coated on both sides with adhesive, firstly the installation space of the membrane-electrode arrangement is defined, secondly the connection of two membrane-electrode units is produced with the current discharger to form a common arrangement and thirdly the thus designed arrangement is sealed relative to the environment.

Furthermore, it is advantageous if the supply possibility for fuel is configured as a plurality of distributor channels and/or the supply possibility for the oxidant is configured as a plurality of distributor channels.

The selection with respect to the single cells is not subject to any general restriction, however, it is advantageous if alkaline or basic planar fuel cells, in particular direct alcohol fuel cells, are used. Further advantageous embodiments provide that the single cells are selected from the group comprising polymer-electrolyte membrane fuel cells (PEM), methanol fuel cells (DMFC), ethanol fuel cells (DEFC), ceramic fuel cells (SOFC) and/or combinations hereof.

Fuel cell systems of this type can be used in particular for supplying electronic units, the operation of which must be ensured over very long periods of time and the energy consumption of which is low, such as for example sensors from environment monitoring, traffic measuring technology and routing systems, GSM/GPS/GPRS navigation systems and combinations thereof, battery charging systems, housing-integrated energy supply units in applications from the electronic consumer sphere, e.g. PDA, mobile telephone, laptop, recording devices (e.g. card readers of the German railway, UPS etc.), intelligent/functional housings or packagings.

The present invention is explained in more detail with reference to the subsequently illustrated Figure without wishing to restrict the invention to the special parameters reproduced in the Figure.

The Figure thereby shows two single cells disposed in a shingle construction, i.e. tilted, which are connected to a fuel cell arrangement.

The single cells respectively have a current discharger structure 1 fitted on the anode side, channels abutting against this current discharger structure 1 for fuel distribution 2, a membrane-electrode arrangement (MEA) which is disposed on the side orientated away from the fuel distributor channels 2 and comprises an anode-side electrode 6, a membrane 5 abutting thereon and also a cathode-side electrode 4 and also a cathode-side current discharger structure 8 to which a plurality of oxidation channels 7 is connected. According to the invention, the single cells are thereby connected in series in that the current discharger structure 1 which forms the anode of the first fuel cell is connected directly to the current discharger structure 8 of the right single cell. Hence the requirement for connecting the single cells via additional aids, such as for example contacts, cell connectors or cables, is dispensed with. The single cells are thereby integrated in one housing 3 so that the complete fuel cell module is produced as a single unit. It is thereby evident that the fuel cells are disposed in a manner corresponding to a non-parallel arrangement of the fuel cells relative to the housing (in this perspective illustration relative to the upper and lower side of the housing). The arrangement of the single cells is thereby effected in a tilted manner relative to the housing 3. The angle which the normal 9 to the current discharger structure 1 or 8 includes with the directional vector 10, in the direction of which the single cells are disposed one following the other, is between 5° and 85°.

1. A fuel cell arrangement comprising at least two electrochemical single cells, each electrochemical single cell being constructed at least from the following components:
a) at least one current discharger structure disposed on the anode side,
b) a supply possibility for fuel,
c) an electrode-membrane arrangement (MEA), comprising an anode-side electrode, a membrane and a cathode-side electrode,
d) a supply possibility for the oxidant, and also
e) at least one current discharger structure disposed on the cathode side,
wherein each electrochemical single cell is connected electrically directly to at least one adjacent electrochemical single cell and is disposed offset relative to the at least one adjacent electrochemical single cell.

2. The fuel cell arrangement according to claim 1, wherein the single cells are disposed non-parallel to each other.

3. The fuel cell arrangement according to claim 1, wherein the fuel cells are disposed in a shingle construction.

4. The fuel cell arrangement according to claim 1, wherein the electrochemical single cells are disposed one- and/or two-dimensionally.

5. The fuel cell arrangement according to claim 4, wherein the at least two electrochemical single cells are disposed one-dimensionally such that the normal to the current discharger structures with the directional vector, in the direction of which the single cells are connected, includes an angle α which is between 5° and 85°.

6. The fuel cell arrangement according to claim 1, wherein the two current discharger structures are configured plane-parallel to each other.

7. The fuel cell arrangement according to claim 1, wherein each electrochemical single cell is connected directly in series to at least one adjacent electrochemical single cell.

8. The fuel cell arrangement according to claim 1, wherein the fuel cell contains at least three electrochemical single cells, the terminal single cells of the fuel cell respectively being connected electrically directly to an adjacent single cell, whilst the at least one single cell disposed therebetween is connected respectively electrically directly to respectively two adjacent single cells.

9. The fuel cell arrangement according to claim 1, wherein, in the case of the terminal electrochemical single cells of the fuel cell respectively, either the current discharger structures disposed on the anode side or cathode side are not connected to an adjacent single cell, whilst, in the case of the single cells disposed therebetween, both the current discharger structure disposed on the anode side and cathode side are connected to respectively at least one adjacent single cell.

10. The fuel cell arrangement according to claim 1, wherein the one terminal electrochemical single cell has a current discharger structure disposed on the anode side, which is not connected to an adjacent electrochemical single cell and the other terminal electrochemical single cell has a current discharger structure disposed on the cathode side, which is not connected to an adjacent single cell.

11. The fuel cell arrangement according to claim 1, wherein respectively both the current discharger structure, disposed on the anode side, of an electrochemical single cell disposed between the terminal electrochemical single cells of the fuel cell is connected electrically directly to the current discharger structure, disposed on the cathode side, of its adjacent single cell and respectively the current discharger structure, disposed on the cathode side, of this single cell is connected electrically directly to the current discharger structure, disposed on the anode side, of its adjacent single cell.

12. The fuel cell arrangement according to claim 1, wherein the at least two electrochemical single cells are integrated in one housing.

13. The fuel cell arrangement according to claim 1, wherein the at least two electrochemical single cells are glued together via spacers.

14. The fuel cell arrangement according to claim 1, wherein the supply possibility for fuel is configured as a plurality of distributor channels and the supply possibility for the oxidant is configured as a plurality of distributor channels.

15. The fuel cell arrangement according to claim 1, wherein at least one electrochemical single cell is selected from the group comprising polymer-electrolyte membrane fuel cells (PEM), methanol fuel cell (DMFC), ethanol fuel cells (DEFC), ceramic fuel cells (SOFC) and/or combinations hereof

16-17. (canceled)

18. The fuel cell arrangement according to claim 2, wherein the fuel cells are disposed in a shingle construction.

19. The fuel cell arrangement according to claim 2, wherein the electrochemical single cells are disposed one- and/or two-dimensionally.

20. The fuel cell arrangement according to claim 2, wherein the two current discharger structures are configured plane-parallel to each other.

21. A method of providing current supply to an electrically operated device and/or an electronic unit, comprising utilizing the fuel cell arrangement according to claim 1.

22. The method according to claim 21, wherein the electrical device and/or the electronic unit is selected from the group consisting of sensors, devices for traffic measuring technology and routing systems; GSM, GPS- and/or GPRS navigation systems;
battery charging systems; housing-integrated energy supply units for applications from the consumer sphere, recording devices, and intelligent and/or functional housings and/or packagings.
